(19) United States
(12) Patent Application Publication
(10) Pub. No.: US 2023/0367908 A1
(43) Pub. Date: Nov. 16, 2023

(54) PRIVACY ENHANCED SENSOR ACCESS

(71) Applicant: Shopify Inc., Ottawa (CA)

(72) Inventor: Jonathan Wade, Ottawa (CA)

(21) Appl. No.: 17/742,566

(22) Filed: May 12, 2022

(51) Int. Cl. G06F 21/62; G06F 21/82; G06F 21/44

(52) U.S. Cl. CPC G06F 21/629; G06F 21/44; G06F 21/6227; G06F 21/82

(57) ABSTRACT

Systems and methods are disclosed for providing an application executing on a user device access to particular data derived from a sensor of the user device in such a manner that privacy is maintained. In one embodiment, a computer-implemented method comprises receiving, by a software component on a user device from an application executing on the user device, a request to access a sensor of the user device. The method further comprises determining, by the software component, that the application is permitted to receive particular data derived from the sensor. The method further comprises, responsive to determining that the application is permitted to receive particular data derived from the sensor, obtaining, by the software component, sensor data output by the sensor; determining, by the software component, the particular data based on the sensor data; and providing, by the software component, the particular data to the application.

### TECHNICAL FIELD

The present disclosure relates to enabling an application or website access to a sensor (e.g., camera) of a user device and, more specifically, to enabling such access in a manner that increases user privacy.

### BACKGROUND

Modern electronic devices are typically equipped with various types of sensors such as, e.g., cameras, microphones, accelerometers, gyroscopes, etc. A user desires to share data from such sensors with various types of applications. For example, a live video stream from a camera on a user’s smartphone or personal computer is utilized by video conferencing applications such as, e.g., Microsoft® Teams, Zoom, etc. As another example, pictures captured by a camera of a user’s smartphone or personal computer are utilized by social media applications such as, e.g., Snapchat, Instagram, etc.

Allowing non-trusted or third-party applications to access sensor data from sensors of a user’s device creates a substantial privacy concern for the user. Some mobile operating systems (e.g. Android (TM)) try to address such concerns by allowing users to decide whether or not to grant access/permission to a given third-party application to access a given sensor (e.g., the camera of the user’s device.)

### SUMMARY

As noted above, allowing non-trusted or third-party applications to access sensor data from sensors of a user’s device creates a substantial privacy concern for the user. However, such concerns are not reliably mitigated by allowing users to decide whether or not to grant access/permission to a given third-party application to access a given sensor. For example, importantly, once a user grants permission to a third-party application to access a sensor such as a camera of the user’s device, the third-party application has full access to sensor data from that sensor. In other words, access to the sensor data is unconstrained.

While this privacy concern exists with smartphones and personal computers, this privacy concern is further complicated for Augmented Reality (AR) and Virtual Reality (VR) devices. For instance, an AR/VR headset normally includes many cameras that provide a 360° or nearly 360° live video stream of a user’s environment. Since an AR/VR headset is often worn by a user in private locations (e.g., the user’s home, office, bedroom, etc.), there is a chance that unintended information about people or objects in the user’s environment would be provided to third-party applications if those applications are given access to the cameras of the user’s AR/VR headset.

Thus, there is a need for increasing privacy when enabling applications to access data from sensors of a user’s device.

Systems and methods are disclosed for providing an application executing on a user device access to particular data derived from sensor data output by a sensor of the user device in such a manner that privacy is maintained, at least to a defined level of privacy. In one embodiment, a computer-implemented method comprises receiving, by a software component on a user device from an application executing on the user device, a request to access a sensor of the user device. The method further comprises determining, by the software component, that the application is permitted to receive particular data derived from the sensor. The method further comprises, responsive to determining that the application is permitted to receive particular data derived from the sensor, obtaining, by the software component, sensor data output by the sensor; determining, by the software component, the particular data based on the sensor data; and providing, by the software component, the particular data to the application. In this manner, the particular data, rather than the sensor data, is provided to the application, which maintains user privacy.

In one embodiment, the particular data derived from the sensor is different than the sensor data output by the sensor.

In one embodiment, determining the particular data based on the sensor data comprises filtering or transforming the sensor data to thereby provide the particular data derived from the sensor.

In one embodiment, determining the particular data based on the sensor data comprises determining the particular data based on: (a) information provided by the application that defines the particular data, (b) information provided by a developer of the application that defines the particular data, (c) information provided by the application that defines a manner in which the sensor data is to be filtered or transformed to provide the particular data; or (d) information provided by the developer of the application that defines a manner in which the sensor data is to be filtered or transformed to provide the particular data.

In one embodiment, determining the particular data based on the sensor data comprises determining the particular data based on the sensor data and known information about the application or a function of the application.

In one embodiment, the software component is an operating system or operating system component of the user device or has a trusted relationship therewith. In one embodiment, the application does not have a trusted relationship with the operating system or operating system component of the user device.

In one embodiment, the application is a web browser, the request is associated to a particular website or webpage, and determining that the application is permitted to receive the particular data derived from the sensor comprises determining that the particular website or webpage is permitted to receive the particular data derived from the sensor.

In one embodiment, the software component is a web browser, the application is a web application, and determining that the application is permitted to receive the particular data derived from the sensor comprises determining that the web application is permitted to receive the particular data derived from the sensor.

In one embodiment, determining that the application is permitted to receive the particular data derived from the sensor comprises determining that the application is permitted to receive the particular data derived from the sensor based on one or more user-defined or Operating System (OS) -defined permissions for the application.

In one embodiment, the sensor comprises at least one of a camera, a microphone, an accelerometer, or a gyroscope.

In one embodiment, the software component supports requests for one or more types of particular data for one or more types of sensors.

In one embodiment, the user device comprises a plurality of software components each supporting requests for different types of particular data derived from the sensor, particular data for one or more different types of sensors, or both.

In one embodiment, the method further comprises presenting, by the software component via an output component of the user device, a prompt that requests user confirmation that sharing of the particular data with the application is allowed and receiving user input responsive to the prompt, wherein providing the particular data to the application comprises providing the particular data to the application only if the user input indicates that sharing of the particular data with the application is allowed.

In one embodiment, the user device is or includes at least one of a smartphone, a tablet computer, a personal computer (e.g., a laptop computer), or an Augmented Reality (AR) / Virtual Reality (VR) device.

In one embodiment, the user device is or includes an AR/VR device, the sensor is a camera comprised in the AR/VR device, and obtaining the sensor data from the sensor comprises obtaining a picture or a live video stream from the camera, determining the particular data based on the sensor data comprises extracting a user authentication token from the obtained picture or live video stream, and providing the particular data to the application comprises providing the user authentication token to the application.

In one embodiment, the user device is an AR/VR device and the sensor is a camera included in the AR/VR device. In addition, the method further comprises, at the application on the AR/VR device, initiating an e-commerce transaction with an e-commerce system and sending the request to the software component during the e-commerce transaction, wherein the particular data requested by the request comprises a user authentication token to be obtained via the camera of the AR/VR device. At the software component, obtaining the sensor data from the sensor comprises obtaining a picture or a live video stream from the camera, determining the particular data based on the sensor data comprises extracting the user authentication token from the obtained picture or live video stream, and providing the particular data to the application comprises providing the user authentication token to the application. The method further comprises, at the application on the AR/VR device, receiving the user authentication token from the software component responsive to the request and providing the user authentication token to the e-commerce system. In one embodiment, extracting the user authentication token from the obtained picture or live video stream comprises detecting a machine-readable indicia in the obtained picture or live video stream and extracting the user authentication token from the machine-readable indicia.

Embodiments of a user device are also disclosed. In one embodiment, the user device comprises a sensor, processing circuitry, and memory comprising instructions executable by the processing circuitry whereby the processing circuitry causes the user device to: receive, at a software component of the user device from an application executing on the user device, a request to access the sensor and determine, by the software component, that the application is permitted to receive particular data derived from the sensor. Via the executable instructions, the processing circuitry further causes the user device to, responsive to the software component determining that the application is permitted to receive particular data derived from the sensor, obtain, by the software component, sensor data from the sensor; determine, by the software component, the particular data based on the sensor data; and provide, by the software component, the particular data to the application.

Embodiments of a non-transitory computer-readable medium are also disclosed. In one embodiment, a non-transitory computer-readable medium comprises instructions executable by a processor of a user device whereby the user device is operable to receive, by a software component on a user device from an application executing on the user device, a request to access a sensor of the user device and determine, by the software component, that the application is permitted to receive particular data derived from the sensor. Via the executable instructions, the user device is further operable to, responsive to the software component determining that the application is permitted to receive particular data derived from the sensor, obtain, by the software component, sensor data output by the sensor; determine, by the software component, the particular data based on the sensor data; and provide, by the software component, the particular data to the application.

### BRIEF DESCRIPTION OF THE DRAWINGS

The accompanying drawings figures incorporated in and forming a part of this specification illustrate several aspects of the disclosure, and together with the description server to explain the principles of the disclosure.

FIG. 1 illustrates a system including a privacy function that operates to provide an application executing on a user device access to particular data (e.g., filtered or transformed information) extracted or derived from sensor data output by a sensor of the user device in accordance with an embodiment of the present disclosure;

FIG. 2 illustrates one example of a user device that includes a software component 202 that implements the privacy function 162 of FIG. 1 in accordance with an embodiment of the present disclosure;

FIG. 3 illustrates the operation of the user device of FIG. 2 in accordance with one embodiment of the present disclosure;

FIG. 4 illustrates one example embodiment of a procedure in which the software component that implements the privacy function is used for user authentication during an express checkout procedure where the user device is an Augmented Reality (AR) / Virtual Reality (VR) headset;

FIG. 5 illustrates step 416 of FIG. 4 in more detail, in accordance with one embodiment of the present disclosure;

FIG. 6 illustrates one example embodiment of an electronic device in which embodiments of the present disclosure may be implemented;

FIG. 7 illustrates an example e-commerce platform 100, according to one embodiment of the present disclosure; and

FIG. 8 depicts a non-limiting embodiment for a home page of an administrator.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Note that, as used herein, the term “comprising” (and other forms of the word “comprise”) is which is synonymous with “including,” “containing,” or “characterized by,” and is inclusive or open-ended and does not exclude additional, unrecited elements or steps. Conversely, the term “consisting of” (and other related forms) is synonymous with “including,” “containing,” or “characterized by,” but is exclusive in that it excludes additional, unrecited elements or steps.

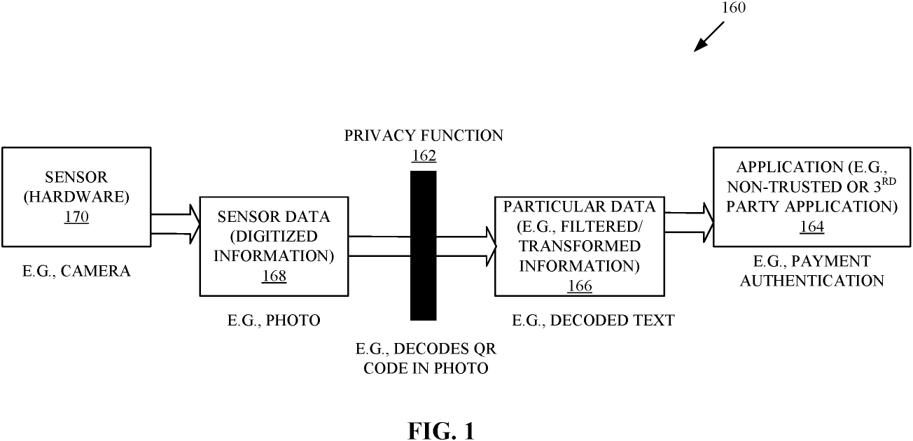

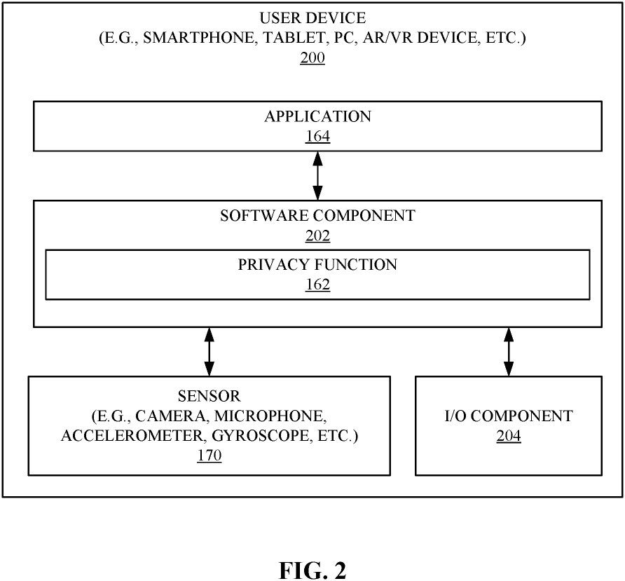

Systems and methods are disclosed herein for providing an application (e.g., a non-trusted, a third-party application, a web browser rendering a particular website, a web application, etc.) executing on a user device (e.g., an Augmented Reality (AR) / Virtual Reality (VR) device such as an AR/VR headset, a smartphone, a tablet computer, a personal computer, or the like) access to particular data (e.g., filtered sensor data or transformed sensor data) extracted or derived from sensor data output by a sensor(s) (e.g., a camera, a microphone, a gyroscope, an accelerometer, or the like) of the user device in such a manner that privacy is maintained, at least to a defined level of privacy. In this regard, FIG. 1 illustrates a system 160 including a privacy function 162 that operates to provide an application 164 executing on a user device (not shown) access to particular data 166 (e.g., filtered or transformed information) extracted or derived from sensor data 168 output by a sensor 170 of the user device. The sensor 170 may be, for example, a camera in which case the sensor data 168 may be a digital photograph or a video (e.g., a live video stream), a microphone in which the sensor data 168 is a digital audio file or stream, an accelerometer in which case the sensor data 168 is digitized information that represents one or more output values of the accelerometer, a gyroscope in which case the sensor data 168 is digitized information that represents one or more output values of the gyroscope, or the like. As discussed below in detail, the privacy function 162 is, at least in some embodiments, implemented as a software component of the user device (see, e.g., the software component 202 of the user device 200 of FIG. 2). This software component may be an Operating System (OS) of the user device, a component of the OS of the user device, a software component having a trusted relationship with the OS or OS component of the user device, or the like. The application 164 is, e.g., a non-trusted application (i.e., an application that does not have a trusted relationship with the OS or OS component of the user device), a third-party application, a web browser (e.g., browsing a website), a web application, or the like. As one example implementation, the software component that implements the privacy function 162 is the OS or a component of the OS of the user device, and the application 164 is an untrusted application or code executing on the user device that desires access to the sensor 170. As another example implementation, the software component that implements the privacy function 162 is a web browser that is executing on the user device and has a trusted relationship with the OS or user, and the application 164 is a website or webpage being browsed by the web browser, a web application being executed by the web browser, Hyper-Text Markup Language (HTML) code being rendered or executed by the web browser, a WebXR application being executed by the web browser, or the like.

As described below, the privacy function 162 operates to maintain privacy, at least to a desired degree, by providing the application 164 access to the particular data 166, rather than the sensor data 168. Note that the sensor data 168 is also referred to herein as “raw sensor data,” which as used herein refers to the digitized information output by the sensor 170. The particular data 166 to which the application 164 is provided access may vary depending on the type of sensor. In general, the particular data 166 is something other than the sensor data 168, where this particular data 166 is somehow derived from the sensor data 168, e.g., by filtering or transforming the sensor data 168, by extracting less than all of the sensor data 168, etc. Some non-limiting examples are as follows:
Camera:
   In one example, the sensor 170 is a camera, the sensor data 168 is a digital photo or video stream (e.g., a live video stream) output by the camera, and the privacy function 162 decodes a Quick Response (QR) code or other machine-readable indica (e.g., a bar code, a Universal Product Code (UPC), or the like) in the digital photo or video stream such that the particular data 166 output by the privacy function 162 is decoded text or a decoded alphanumeric string derived by decoding the QR code or other machine-readable indicia in the digital photo or video stream. The privacy function 162 provides this decoded text or decoded alphanumeric string, rather than the digital photo or video stream, to the application 164. In this manner, privacy of the user is maintained. Note that a QR code may use International Organization for Standardization (ISO) / International Electrotechnical Commission (IEC) 18004:2015 or another standard to encode data within an image.
   In one example, the sensor 170 is a camera, the sensor data 168 is a digital photo or video stream (e.g., a live video stream) output by the camera, and the privacy function 162 extracts desired information (e.g., Uniform Resource Locator (URL), credit card information from a credit card, serial number, text label(s) of object(s) in the image/video, or the like) from the digital photo or video stream such that the particular data 166 output by the privacy function 162 is desired information extracted from the digital photo or video stream. The privacy function 162 provides this extracted information, rather than the digital photo or video stream, to the application 164. In this manner, privacy of the user is maintained. Information regarding one example of a process which can be used to extract text labels of objects in images which can be used in an embodiment of the present disclosure is described in Justin Johnson, Andrej Karpathy, and Li Fei-Fei. DenseCap: Fully Convolutional Localization Networks for Dense Captioning, Proceedings of the IEEE Conference on Computer Vision and Pattern Recognition,, 2016, which is hereby incorporated by reference for its teachings regarding this aspect.
   In another example, the sensor 170 is a camera, the sensor data 168 is a digital photo output by the camera, and the privacy function 162 processes the digital photo to provide a low-resolution version of the digital photo such that the particular data 166 output by the privacy function 162 is the low-resolution version of the digital photo. The privacy function 162 provides this low-resolution version of the digital photo, rather than the digital photo, to the application 164.
   In another example, the sensor 170 is a camera, the sensor data 168 is a digital photo output by the camera, and the privacy function 162 filters or transforms the digital photo to, e.g.:
      remove or blur or replace certain areas or objects that appear in the digital photo (e.g., remove or blur people’s faces, remove or blur or replace the background, remove or replace or blur some defined (e.g., user-defined) area within the digital photo (e.g., blur an area within the digital photo that corresponds to a user-defined area for which privacy is desired);
      provide only a portion(s) (e.g., a cropped version) of the digital photo in which an object(s) appears in the digital photo that matches some predefined object(s) (e.g., a person’s face, an object that appears in the digital photo that matches a digital photo of a particular object provided by the application 164), at least to a predefined or preconfigured threshold degree. This may be beneficial to, for example, provide proof-of-purchase of a particular item;
      provide a Boolean response that indicates whether a desired object is present in the digital photo output by the camera where the Boolean response is the particular data 166 returned to the application 164;
      detect text (e.g., via Optical Character Recognition (OCR)) in the digital photo output by the camera where the detected text is the particular data 166 returned to the application 164; or
      detect only a dominant or prominent color(s) in the digital photo output by the camera where particular data 166 returned to the application 164 is information that indicates the detected dominant color(s) or a version of the digital photo in which only the dominant color(s) is present.
      The privacy function 162 provides this filtered or transformed version of the digital photo, rather than the digital photo, to the application 164.
   In another example, the sensor 170 is a camera, the sensor data 168 is a set of digital photos output by the camera, and the privacy function 162 processes the digital photo to provide a subset of the set of digital photos such that the particular data 166 output by the privacy function 162 is the subset of the set of digital photos output by the camera. The privacy function 162 provides this subset, rather than the full set of digital photos, to the application 164.
   In another example, the sensor 170 is a camera, the sensor data 168 is a digital video or a digital video stream (e.g., a live video stream) output by the camera, and the privacy function 162 processes this digital video to provide a low-resolution version of the digital video or filters or transforms the digital video (e.g., in the same manner as described above for the digital photo example) such that the particular data 166 output by the privacy function 162 is the low-resolution, filtered, or transformed version of the digital video. The privacy function 162 provides this low-resolution, filtered, or transformed version of the digital video, rather than the digital video, to the application 164.
   In another example, the sensor 170 is a camera, the sensor data 168 is a digital video or a digital video stream (e.g., a live video stream) comprising a set of video frames output by the camera, and the privacy function 162 processes this digital video to provide a subset of the set of video frames such that the particular data 166 output by the privacy function 162 is the subset of the set of video frames output by the camera. The privacy function 162 provides this subset, rather than the full set of video frames, to the application 164.
Microphone:
   In one example, the sensor 170 is a microphone, the sensor data 168 is digital audio (e.g., a digital audio file or digital audio stream) output by the microphone, and the privacy function 162 processes the digital audio to provide a low-resolution version of the digital audio such that the particular data 166 output by the privacy function 162 is the low-resolution version of the digital audio. The privacy function 162 provides this low-resolution version of the digital audio, rather than the digital audio, to the application 164.
   In another example, the sensor 170 is a microphone, the sensor data 168 is digital audio (e.g., a digital audio file or digital audio stream) output by the microphone, and the privacy function 162 filters or transforms the digital audio to, e.g.,
      remove or mute or replace certain segments of the digital audio (e.g., remove or mute segments of the digital audio in which certain (e.g., predefined or configured) words or sounds occur);
      remove or mute or replace background noise or sounds;
      include only a segment(s) of the digital audio that matches certain criteria (e.g., the user is speaking or a certain (e.g., predefined or configured) word(s) or sound(s) occurs); or
      mask the user’s voice by, e.g., shifting a pitch, processing with a vocoder, filter, or otherwise altering one or more audio characteristics of the digital audio.
      The privacy function 162 provides this filtered or transformed version of digital audio, rather than the digital audio, to the application 164.
Accelerometer:
   In one example, the sensor 170 is an accelerometer, the sensor data 168 is one or more digital samples output by the accelerometer, and the privacy function 162 processes the digital samples to provide a low-resolution version of the digital samples (e.g., samples at a reduced periodicity, samples with reduced resolution, or the like) such that the particular data 166 output by the privacy function 162 is the low-resolution version of the digital samples output by the accelerometer. The privacy function 162 provides this low-resolution version of the digital samples output by the accelerometer, rather than the digital samples output by the accelerometer, to the application 164.
   In one example, the sensor 170 is an accelerometer, the sensor data 168 is one or more digital samples output by the accelerometer, and the privacy function 162 processes the digital samples to provide transformed information such as, e.g., a step-count (i.e., a count of a number of steps taken by the user, e.g., over some defined amount of time). The particular data 166 output by the privacy function 162 is the transformed information derived from the digital samples output by the accelerometer. The privacy function 162 provides this transformed information, rather than the digital samples output by the accelerometer, to the application 164.
Gyroscope:
   In one example, the sensor 170 is a gyroscope, the sensor data 168 is one or more digital samples output by the gyroscope, and the privacy function 162 processes the digital samples to provide a low-resolution version of the digital samples (e.g., samples at a reduced periodicity, samples with reduced resolution, or the like) such that the particular data 166 output by the privacy function 162 is the low-resolution version of the digital samples output by the gyroscope. The privacy function 162 provides this low-resolution version of the digital samples output by the gyroscope, rather than the digital samples output by the gyroscope, to the application 164.
Lidar
   In one example, the sensor 170 is a lidar, the sensor data 168 is one or more time of flight distance measurements or point clouds output by the lidar and the privacy function 162 processes the measurements or point clouds to provide a lower resolution dataset. In this example the lidar may be capable of high resolution measurements to create a biometric capable of uniquely identifying a person. The output of the privacy function 162 is a set of data (measurements or pointcloud) capable of determining if the person would best fit a medium sized baseball cap or a large baseball cap, while not containing the precise data that uniquely fingerprints the person.
Note that the output of the sensor 170 may be raw data or data that has been processed by a processing pipeline. Using a camera an example, the sensor data received from the camera may be a raw image or video data or a processed image or video data (e.g., a Joint Photographic Experts Group (JPEG) image in the case of an image or a Moving Picture Experts Group (MPEG) video in the case of a video). The processed image or video data may have been passed to a processing pipeline which includes obtaining a raw image/video from an image/video sensor, image/video signal processing, lens correction, etc. Further, the sensor data may be compressed or uncompressed. In a similar manner, the sensor data from other types of sensors may be the raw data from the sensor 170 or processed data.

Note that the manner in which the particular data is derived (e.g., particular filter or transformation applied by the privacy function 162 may be requested by the application 164, configured by the user of the user device, or defined by some other entity (e.g., defined by an enterprise policy)). For example, the user may select an area(s) within the field of view of the camera of the user’s device to remove or blur or replace or select an area(s) within the field of view of the camera of the user’s device to allow while filtering (removing or blurring or replacing) the rest of the field of view of the camera. The manner in which the particular data is derived may, e.g., be set by the user and may be application specific, at install time, run time, or both. The filter or transformation used may be set by the OS of the user device, by a browser Application Programming Interface (API), by a third-party application API, or configured by the developer of the application 164. Further, which type of filter or transformation is allowed or denied may be user-configured or otherwise defined (e.g., defined by an enterprise policy).

FIG. 2 illustrates one example of a user device 200 that includes a software component 202 that implements the privacy function 162 of FIG. 1 in accordance with an embodiment of the present disclosure. As illustrated, the user device 200 includes the software component 202, the application 164, the sensor 170, and one or more Input/Output (I/O) components 204. The I/O components 204 may include, for example, a touchscreen, a display (including wearable displays), a keypad, a trackpad, or the like.

It should be noted that there may be a single software component 202 that supports multiple types of particular data and/or multiple sensor types and/or multiple types of applications. This may be done, e.g., via corresponding APIs. Alternatively, there may be multiple software components 202 (e.g., implemented via multiple plugins for a web browser) for the same sensor 170, where each software component 202 provides access to one or more types of particular data for the particular sensor (e.g., one software component for reading a QR code from a picture captured by a camera, another software component for detecting a credit card in a picture captured by the camera and outputting information from the credit card (e.g., credit card number, name, expiration data, etc.), another software component for detecting a barcode in a picture captured by the camera and outputting machine readable indicia of the detected barcode, etc.). Each software component may expose one or more APIs to applications to enable the applications to request the desired filtered or transformed sensor data.

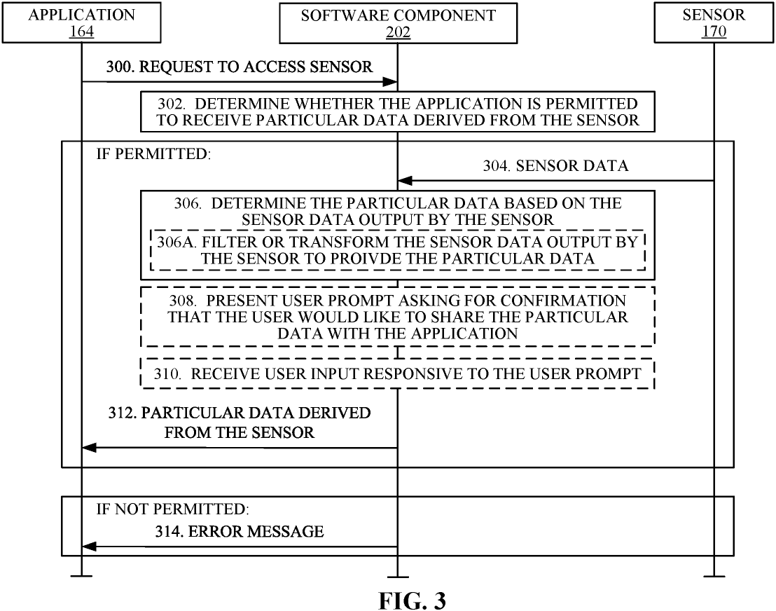

FIG. 3 illustrates the operation of the user device 200 of FIG. 2 in accordance with one embodiment of the present disclosure. Note that dashed lines/boxes represent optional steps. As illustrated, the software component 202 receives, from the application 164, a request for access to the sensor 170 of the user device 200 (step 300). Note that the application 164 preferably does not have direct access to the sensor 170. The software component 202 determines whether the application 164 is permitted to receive particular data 166 derived from the sensor (i.e., derived from the sensor data 168 output by the sensor 170) (step 302). This determination may be based on, e.g., one or more predefined or preconfigured rules or criteria, which may be obtained from a user of the user device 200, obtained from an OS of the user device 200, or obtained from some other source (e.g., a trusted entity that defines the type(s) of particular data that particular applications or types of applications should be allowed to access). The rules or criteria may depend on the application 164, the application type of the application 164, the geographic location of the user device 200, the time of the day at which the request is made, the day of the week on which the request is made, etc. Different applications, different types of applications, or different websites or webpages (when the application 164 corresponds to a web browser browsing a website or webpage) may have different permissions for accessing particular data 166 from the sensor 170. These permissions may be defined by, e.g., the OS, an OS component, the web browser, a user of the user device 200, an enterprise policy, or the like. In addition to or as an alternative to determining whether the application 164 is permitted to access the particular data 166, the software component 202 may, in step 302, determine the particular data 166 that the application 164 is permitted to access. For example, different applications or different types of applications may be permitted to access different particular data.

Note that, in one embodiment, prior to step 302, the software component 202 determines whether the application 164 is permitted to receive the sensor data 168 output by the sensor 170 (rather than only the particular data 166 derived from the sensor data 168 output by the sensor 170). If so, the software component 202 may provide access to the sensor data 168. However, assuming that the application 164 is not permitted to access the sensor data 168, then the software component 202 proceeds with step 302.

If the application 164 is determined to be permitted to access the particular data 166, the software component 202 obtains the sensor data 168 from the sensor 170 (step 304) and determines the particular data 166 based on the sensor data 168 (step 306). As described above, in one embodiment, the software component 202 derives the particular data 166 by filtering or transforming the sensor data 168 output by the sensor 170 to provide the particular data 166 (step 306A). In one embodiment, the software component 202 may determine the particular data 166 based on information provided by the application 164 or some other entity (e.g., a developer of the application 164) that defines the particular data 166 (e.g., defines what particular data is desired) or information provided by the application 164 or some other entity (e.g., a developer of the application 164) that defines the manner in which the particular data 166 is to be derived from the sensor data 168 (e.g., defines the filter or transformation to be used to derive the particular data 166 from the sensor data 168). In one embodiment, the software component 202 determines the particular data 166 based on the sensor data 168 and known information about the application 164 or a function of the application 164. For example, if the sensor 170 is a camera and the application 164 is known to need information extracted from a QR code, then the software component 202 determines that particular data 166 by extracting information from a QR code (e.g., by decoding the QR code) that appears in a digital photo or a live video stream from the camera.

In one embodiment, the software component 202 presents a user prompt via the I/O component 204 that asks for confirmation that the user would like to share the particular data 166 with the application 164 (step 308). In other words, the user prompt may ask the user to approve or deny sharing of the particular data 166 with the application 164. The software component 202 receives user input responsive to the presented user prompt (step 310). Note that, if no user response is received without some defined or configured timeout period, the software component 202 may in one embodiment assume a negative response or in another embodiment assume a positive response. One example alternative to a user prompt is to have an application store review process to determine an acceptable level of permissions to access filtered/derived sensor data. In yet another alternative, an enterprise device management system may determine whether access to filtered/derived sensor data is allowed or denied. Once the particular data 166 is determined and, optionally, upon receiving or assuming a positive response to the optional user prompt of step 308, the software component 202 sends the particular data 166 to the application 164 (step 312).

If the application 164 is not permitted to access the camera as determined in step 302 or if the user denies sharing in step 310, the software component 202 returns an error message to the application 164 (step 314).

The privacy function 162 implemented by the software component 202 of the user device 200 increases privacy to such a level that it opens up new use-cases or improved use-cases for the use of data from sensors (e.g., cameras) for third-party applications or websites. As one non-limiting example, a user may want to authenticate with a payment service to pay for an order of a virtual or real-world product for an express checkout in a virtual or physical retail environment. One example implementation of such a user authentication is as follows. The user is wearing an AR/VR headset and interacting with an online store (also referred to herein as an “e-commerce store”) within a virtual world. When the user has selected items and wants to checkout, the user chooses an express checkout option, and the user’s identity is verified for the express checkout option by displaying machine-readable indica (e.g., a QR code, a barcode, a UPC, or the like) on the user’s smartphone. The user holds up the smartphone, and the camera(s) on the AR/VR headset is able to view machine-readable indicia within the live video feed of the camera(s). The software component implementing the privacy function 162 on the AR/VR headset, acting as a privacy filter, decodes the machine-readable indicia contained in the live video feed of the camera(s) and passes the decoded information, rather than the live video stream, to the application or website. The application or website is not given full access to the camera(s) to scan, which thereby maintains the privacy of the user.

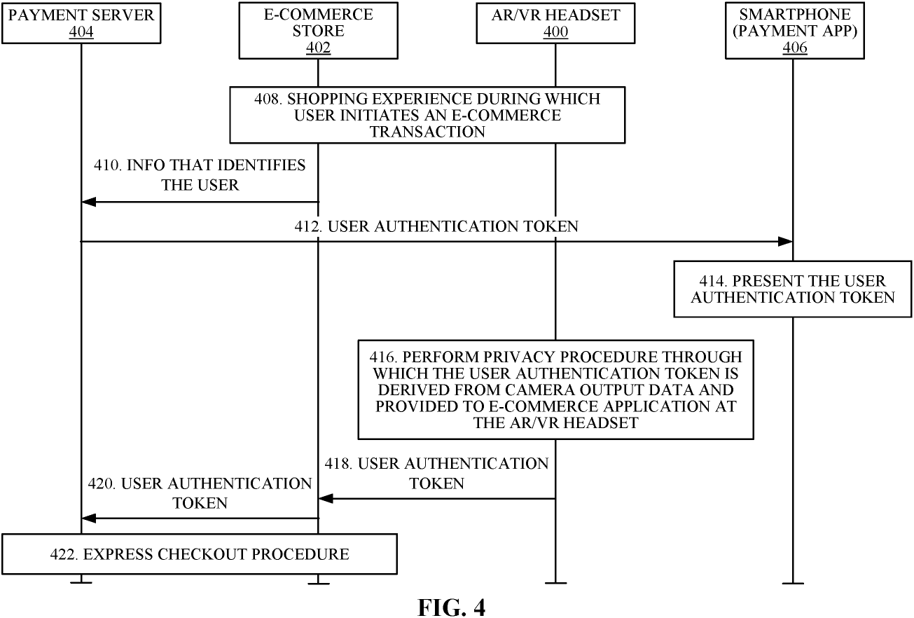

In this regard, FIG. 4 illustrates one example embodiment of a procedure in which the software component 202 is used for user authentication during an express checkout procedure where the user device is an AR/VR headset 400. The procedure of FIG. 4 involves the AR/VR headset 400, an e-commerce store 402, a payment server 404, and a smartphone 406 of the user, where the smartphone 406 executes a payment application associated to the payment server 404. In this example, an express checkout procedure is performed in which an e-commerce transaction is performed on the AR/VR headset 400. As illustrated, via the AR/VR headset 400, a shopping experience is provided during which the user of the AR/VR headset 400 initiates an e-commerce transaction with the e-commerce store 402 (step 408). During an associated express checkout procedure for the e-commerce transaction, the e-commerce store 402 sends information to the payment server 404 that identifies the user (e.g., the user’s email address) (step 410). The payment server 404 generates a user authentication token for the transaction and sends the user authentication token to the user’s smartphone 406 (step 412). The user authentication token may be, e.g., a QR code or a Short Message Service (SMS) message including a machine-readable indicia that serves as a token (e.g., a code, a picture, or the like). The smartphone 406 presents (e.g., displays) the user authentication token (step 414). At the AR/VR headset 400, a procedure is performed through which the user authentication token is derived, via the software component that implements the privacy function 162, from the output (e.g., digital photo or video stream) of a camera of the AR/VR headset 400 (step 416). The AR/VR headset 400 sends the user authentication token to the e-commerce store 402 (step 418), which in turn sends the user authentication token to the payment server 404 (step 420). Once the user is validated based on the user authentication token, the express checkout procedure is then completed (step 422).

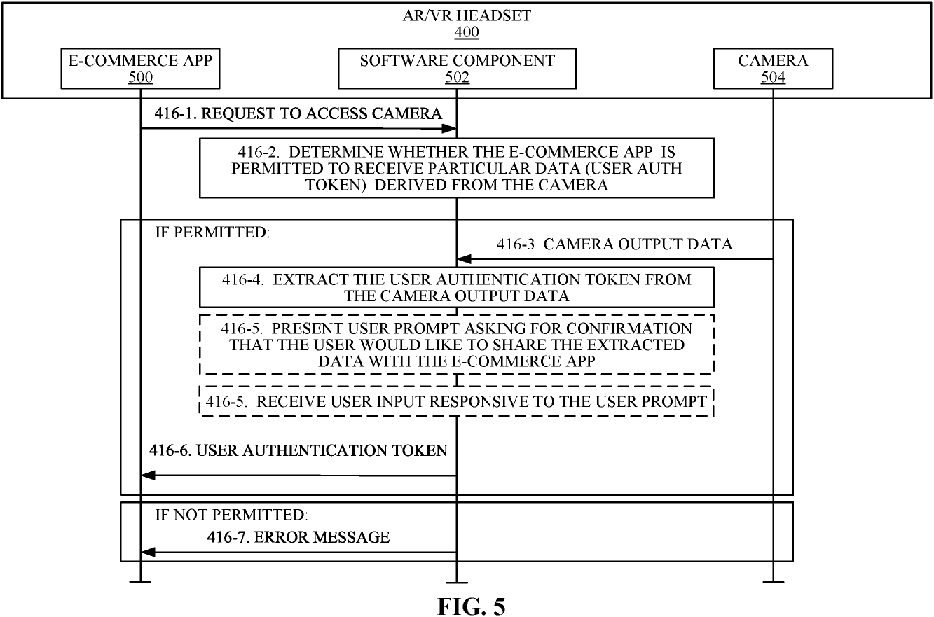

FIG. 5 illustrates step 416 of FIG. 4 in more detail, in accordance with one embodiment of the present disclosure. As illustrated, the AR/VR headset 400 includes an e-commerce application 500, a software component 502, and a camera 504. The e-commerce application 500 is one example of the application 164, the software component 502 is one example of the software component 202, and the camera 504 is one example of the sensor 170. As such, the relevant details regarding the software component 202, the application 164, and the sensor 170 are equally applicable here. As illustrated, in order to obtain the user authentication token, the e-commerce application 500 sends a request to the software component 502 to access the camera 504 (step 416-1). The software component 502 determines whether the e-commerce application 500 is permitted to access particular data from the camera 504 (step 416-2). This may include determining the type of particular data (e.g., a decoded QR code, a decoded barcode, a UPC, or the like) that the e-commerce application 500 is permitted to access from the camera 504. It should be noted that, in one embodiment, the request in step 416-1 may include an indication of what particular data is desired.

If the e-commerce application 500 is determined to have permission to access the particular data from the camera 504, the software component 502 obtains camera output data (e.g., a digital photo, a set of digital photos, or a video stream) from the camera 504 (step 416-3) and extracts the user authentication token from the camera output data (step 416-4). Optionally, the software component 502 may present a user prompt to the user asking if the user approves or denies sharing the user authentication token extracted from the camera output data with the e-commerce application 500 (step 416-5) and receive a user input responsive to the user prompt (step 416-5). Once the user authentication token has been extracted from the camera output data and optionally once user input approving the sharing of the user authentication token with the e-commerce application 500 has been received, the software component 502 sends the user authentication token to the e-commerce application 500 (step 416-6). The e-commerce application 500 may then send the user authentication token to the e-commerce store 402, as described above with respect to step 418 of FIG. 4.

If the e-commerce application 500 is not permitted to access the camera 504 as determined in step 416-2 or if the user denies sharing in step 416-5, the software component 502 returns an error message to the e-commerce application 500 (step 416-7).

Note that embodiments of the present disclosure may be used to enable an AR/VR ecosystem where an AR/VR headset and applications or websites running on it can leverage multiple third-party party payment providers. This is in contrast to the smartphone application world where closed platforms (app stores) can lock-in users to a single first-party payment processing system tied to a device-wide user account. Regulatory activity in some markets is causing existing mobile application platforms to open in-application purchases to third-party payment providers and requirements for similar openness are envisioned for AR/VR devices and platforms.

The express checkout procedure in an e-commerce system is only one example use of the software component. The software component may be used by any application that desires to use data from a sensor(s) of a user device and for which a user desires to maintain privacy. For instance, another example is where the application 164 obtains particular data 166 corresponding to a decoded QR code, a decoded barcode, a decoded UPC, or a serial number of an item to enable the application 164 to, e.g., add the item to the user’s shopping cart, present related product information to the user, present warranty information for the item to the user, present a purchase history related to the item, expedite re-ordering of the item, validate product ownership to, e.g., gate a special reward (e.g., a special AR/VR experience or item(s)), or the like.

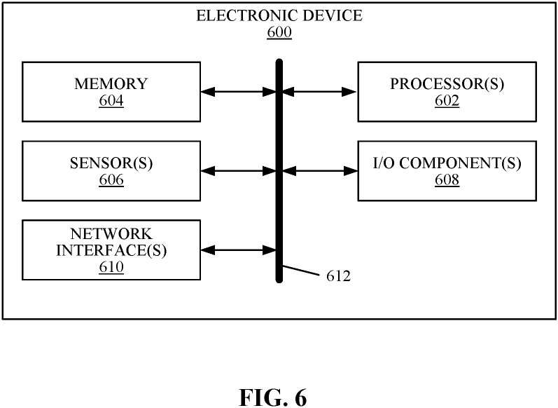

FIG. 6 illustrates one example embodiment of an electronic device 600 in which embodiments of the present disclosure may be implemented. The electronic device 600 is one example embodiment of the user device 200 or the AR/VR headset 400. As illustrated, the electronic device 600 includes one or more processors 602 (e.g., Central Processing Units (CPUs), Application Specific Integrated Circuits (ASICs), Field Programmable Gate Arrays (FPGAs), and/or the like), memory 604, one or more sensors 606, one or more I/O components 608, and one or more network interfaces 610 (e.g., a Wi-Fi network interface, a cellular (e.g., Fifth Generation (5G)) interface, an Ethernet network interface, or the like), connected via a bus 612 or the like. The processors 602 are also referred to herein as processing circuitry. In some embodiments, the software component 202 or 502 and the application 164 or the e-commerce application 500 described above are implemented in software that is stored in the memory 604 and executed by the processor(s) 602. Note that the electronic device 600 may include additional components not illustrated in FIG. 6 such as, e.g., a power supply (e.g., a battery and associated power circuitry), etc.

In some embodiments, a computer program including instructions which, when executed by at least one processor, causes the at least one processor to carry out the functionality of the user device 200, the AR/VR headset 400, or the electronic device 600, and in particular the functionality of the software component 202 or 502, according to any of the embodiments described herein is provided. In some embodiments, a carrier comprising the aforementioned computer program product is provided. The carrier is one of an electronic signal, an optical signal, a radio signal, or a computer-readable storage medium (e.g., a non-transitory computer-readable medium such as memory).

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

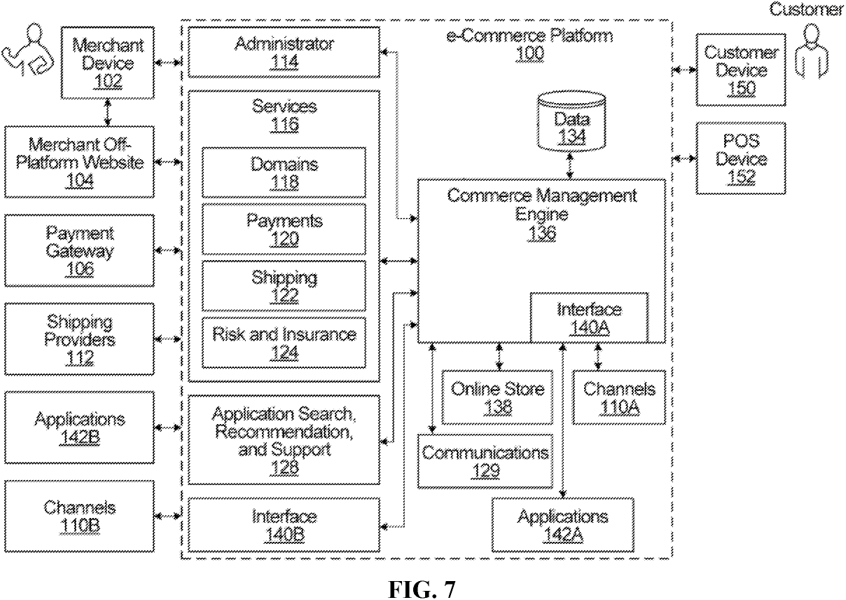

FIG. 7 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 7, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant’s online e-commerce service offering through the e-commerce platform 100, where an online store 138 may refer either to a collection of storefronts supported by the e-commerce platform 100 (e.g., for one or a plurality of merchants) or to an individual merchant’s storefront (e.g., a merchant’s online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant’s storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc.. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store’s product information. It may be that themes can be further customized through a theme editor, a design interface that enables users to customize their website’s design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

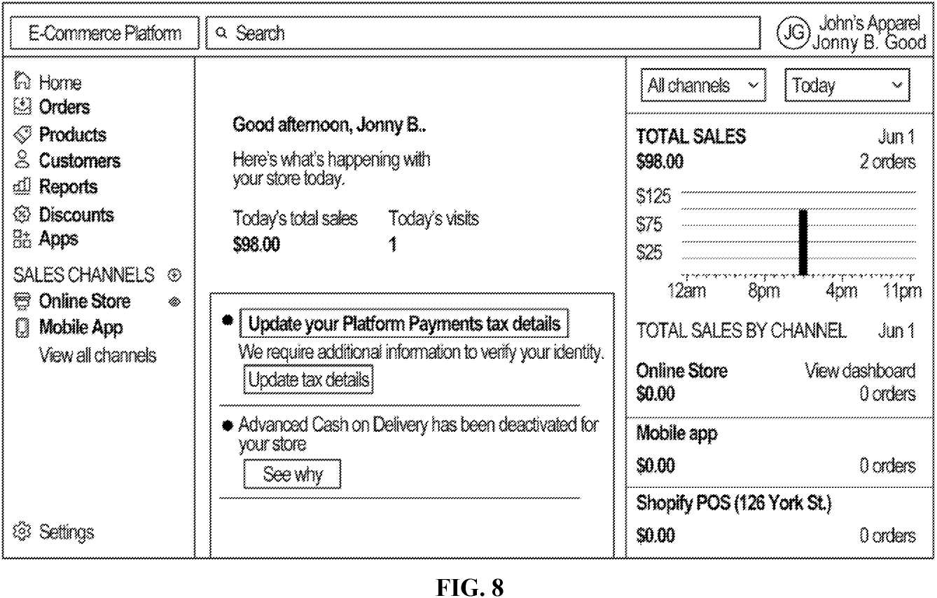

FIG. 8 depicts a non-limiting embodiment for a home page of an administrator 114. The administrator 114 may be referred to as an administrative console and/or an administrator console. The administrator 114 may show information about daily tasks, a store’s recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store’s 138 recent visit or order activity, updating the online store’s 138 catalog, managing orders, and/or the like. In some embodiments, the merchant may be able to access the different sections of the administrator 114 by using a sidebar, such as the one shown on FIG. 8. Sections of the administrator 114 may include various interfaces for accessing and managing core aspects of a merchant’s business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant’s account; and settings applied to a merchant’s online store 138 and account. A merchant may use a search bar to find products, pages, or other information in their store.

More detailed information about commerce and visitors to a merchant’s online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store’s sales and engagement data. An activity feed in the home metrics section may be provided to illustrate an overview of the activity on the merchant’s account. For example, by clicking on a ‘view all recent activity’ dashboard button, the merchant may be able to see a longer feed of recent activity on their account. A home page may show notifications about the merchant’s online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant’s bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 7, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant’s online store 138, perform tasks through the administrator 114, implement new flows for a merchant through a user interface (e.g., that is surfaced through extensions / API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation, and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant’s products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant’s products through a number of different channels 110A-B such as, for example, the merchant’s online store 138, a physical storefront through a POS device 152; an electronic marketplace, through an electronic buy button integrated into a website or a social media channel). In some cases, channels 110A-B may be modeled as applications 142A-B A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer’s contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant’s use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren’t returned and remain in the customer’s hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Those skilled in the art will recognize improvements and modifications to the embodiments of the present disclosure. All such improvements and modifications are considered within the scope of the concepts disclosed herein.

1. A computer-implemented method comprising:
receiving, by a software component on a user device from an application executing on the user device, a request to access a sensor of the user device;
determining, by the software component, that the application is permitted to receive particular data derived from the sensor; and
responsive to determining that the application is permitted to receive particular data derived from the sensor:
obtaining, by the software component, sensor data output by the sensor;
determining, by the software component, the particular data based on the sensor data; and
providing, by the software component, the particular data to the application.

2. The method of claim 1 wherein the particular data derived from the sensor is different than the sensor data output by the sensor.

3. The method of claim 1 wherein determining the particular data based on the sensor data comprises filtering or transforming the sensor data to thereby provide the particular data derived from the sensor.

4. The method of claim 1 wherein determining the particular data based on the sensor data comprises determining the particular data based on: (a) information provided by the application that defines the particular data, (b) information provided by a developer of the application that defines the particular data, (c) information provided by the application that defines a manner in which the sensor data is to be filtered or transformed to provide the particular data; or (d) information provided by the developer of the application that defines a manner in which the sensor data is to be filtered or transformed to provide the particular data.

5. The method of claim 1 wherein determining the particular data based on the sensor data comprises determining the particular data based on the sensor data and known information about the application or function of the application.

6. The method of claim 1 wherein the software component is an Operating System (OS) or OS component of the user device or has a trusted relationship therewith.

7. The method of claim 6 wherein the application does not have a trusted relationship with the OS or OS component of the user device.

8. The method of claim 1 wherein the application is a web browser, the request is associated to a particular website or webpage, and determining that the application is permitted to receive the particular data derived from the sensor comprises determining that the particular website or webpage is permitted to receive the particular data derived from the sensor.

9. The method of claim 1 wherein the software component is a web browser, the application is a web application, and determining that the application is permitted to receive the particular data derived from the sensor comprises determining that the web application is permitted to receive the particular data derived from the sensor.

10. The method of claim 1 wherein determining that the application is permitted to receive the particular data derived from the sensor comprises determining that the application is permitted to receive the particular data derived from the sensor based on one or more user-defined or Operating System (OS) -defined permissions for the application.

11. The method of claim 1 wherein the sensor comprises at least one of a camera, a microphone, an accelerometer, or a gyroscope.

12. The method of claim 1 wherein the software component supports requests for one or more types of particular data for one or more types of sensors.

13. The method of claim 1 wherein the user device comprises a plurality of software components each supporting requests for different types of particular data derived from the sensor, particular data for one or more different types of sensors, or both.

14. The method of claim 1 further comprising:
presenting, by the software component via an output component of the user device, a prompt that requests user confirmation that sharing of the particular data with the application is allowed; and
receiving user input responsive to the prompt;
wherein providing the particular data to the application comprises providing the particular data to the application only if the user input indicates that sharing of the particular data with the application is allowed.

15. The method of claim 1 wherein the user device is or includes at least one of a smartphone, a tablet computer, a personal computer, or an Augmented Reality (AR) / Virtual Reality (VR) device.

16. The method of claim 1 wherein the user device is or includes an Augmented Reality (AR) / Virtual Reality (VR) device, the sensor is a camera comprised in the AR/VR device, and:
obtaining the sensor data from the sensor comprises obtaining a picture or a live video stream from the camera;
determining the particular data based on the sensor data comprises extracting a user authentication token from the obtained picture or live video stream; and
providing the particular data to the application comprises providing the user authentication token to the application.

17. The method of claim 1 wherein the user device is an Augmented Reality (AR) / Virtual Reality (VR) device, the sensor is a camera comprised in the AR/VR device, and the method further comprises:
at the application on the AR/VR device:
initiating an e-commerce transaction with an e-commerce system; and
sending the request to the software component during the e-commerce transaction, wherein the particular data requested by the request comprises a user authentication token to be obtained via the camera of the AR/VR device;
at the software component:
obtaining the sensor data from the sensor comprises obtaining a picture or a live video stream from the camera;
determining the particular data based on the sensor data comprises extracting the user authentication token from the obtained picture or live video stream; and
providing the particular data to the application comprises providing the user authentication token to the application; and
at the application on the AR/VR device:
receiving the user authentication token from the software component responsive to the request; and
providing the user authentication token to the e-commerce system.

18. The method of claim 17 wherein extracting the user authentication token from the obtained picture or live video stream comprises:
detecting a machine-readable indicia in the obtained picture or live video stream; and
extracting the user authentication token from the machine-readable indicia.

19. A user device comprising:
a sensor;
processing circuitry; and
memory comprising instructions executable by the processing circuitry whereby the processing circuitry causes the user device to:
receive, at a software component of the user device from an application executing on the user device, a request to access the sensor;
determine, by the software component, that the application is permitted to receive particular data derived from the sensor; and
responsive to the software component determining that the application is permitted to receive particular data derived from the sensor:
obtain, by the software component, sensor data from the sensor;
determine, by the software component, the particular data based on the sensor data; and
provide, by the software component, the particular data to the application.

20. A non-transitory computer-readable medium comprising instructions executable by a processor of a user device whereby the user device is operable to:
receive, by a software component on a user device from an application executing on the user device, a request to access a sensor of the user device;
determine, by the software component, that the application is permitted to receive particular data derived from the sensor; and
responsive to determining that the application is permitted to receive particular data derived from the sensor:
obtain, by the software component, sensor data output by the sensor;
determine, by the software component, the particular data based on the sensor data; and
provide, by the software component, the particular data to the application.
